(19) United States
(12) Patent Application Publication
(10) Pub. No.: US 2007/0011156 A1
(43) Pub. Date: Jan. 11, 2007

(54) RSS enabled logging

(75) Inventor: Jonathan Maron, Marlton, NJ (US)

Correspondence Address: BINGHAM MCCUTCHEN LLP, 3000 K STREET, NW, BOX IP, WASHINGTON, DC, 20007, US

(73) Assignee: Oracle International Corporation

(21) Appl. No.: 11/173,001

(22) Filed: Jul. 5, 2005

(51) Int. Cl. G06F 17/30

(52) U.S. Cl. 707/6

(57) ABSTRACT

A server provides access to its logging output by using the Really Simple Syndication (RSS) protocol. A method of processing logging information comprises receiving logging information from an application, the logging information relating to an event of the application, processing at least a portion of the received logging information to form at least one information feed, and transmitting at least one of the formed information feeds.

### BACKGROUND OF THE INVENTION

1. Field of the Invention

The present invention relates to a system, method, and computer program product for providing improved performance for queries on local partitioned indexes of spatial data using the root minimum bounding rectangles of the partitions of the indexes.

2. Description of the Related Art

As networks of computer systems continue to grow, it has become common for computer systems in a network to be geographically distributed. Such geographic distribution makes local administration of each system impractical. Instead, remote systems, such as remote workstations and remote servers are better administered remotely. This enables system administration personnel to be located anywhere in a network, while monitoring and administering any and all systems in the network, wherever they may be located.

One important administration function is the capability to examine and analyze the log output from remote systems, such as remote servers. Enabling remote users to view the logging output from a remote server often requires the vendor of the logging software to provide specialized interfaces for querying for the logs as well as for viewing the log output. The creation of these specialized interfaces is time consuming and ultimately the users of the administrative interface must learn to use a proprietary, one-off tool to view the logs to ascertain the reason for any potential problem. In addition, in many instances this log is a composite of the output from multiple components of the server and may be difficult to digest.

A need arises for an improved technique by which access to remote server logging information may be provided, which does not require specialized interfaces and which provides improved ease of use and improved comprehension of the logging information by the user.

### SUMMARY OF THE INVENTION

In accordance with the present invention, a server provides access to its logging output by leveraging the Really Simple Syndication (RSS) protocol. This is a standard protocol for sharing content over the web. Multiple products exist in the market today for viewing RSS content and web browsers are lining up to support the protocol natively. This provides access to remote server logging information, which does not require specialized interfaces and which provides improved ease of use and improved comprehension of the logging information by the user.

RSS may be utilized in the present invention by defining a channel (or feed) per loggable component of the server. The available channels are defined in an RSS document made available by the server. The various logging channels can be mapped directly to component logs. For example, in Java, the java.util.logging package can be leveraged to define channels to which components log. By registering log handlers to output the RSS feeds for the components the java channels could be directly mapped to RSS channels.

In one embodiment of the present invention, a method of processing logging information comprises receiving logging information from an application, the logging information relating to an event of the application, processing at least a portion of the received logging information to form at least one information feed, and transmitting at least one of the formed information feeds.

In one aspect of the present invention, the information feed is a Really Simple Syndication protocol feed. Receiving logging information from an application comprises receiving logging information sent by a logging call made by the application at a logger object and passing the logging information to a handler. The processing comprises receiving the logging information at the handler, and processing the received logging information at the handler to form the at least one Really Simple Syndication protocol feed. The logger object is a JAVA logger object.

In one embodiment of the present invention, a method of configuring a server to transmit logging information comprises configuring a log handler for a logger object, configuring a logging level for the logger object, and initiating a logging information feed from the log handler.

In one aspect of the present invention, the information feed is a Really Simple Syndication protocol feed. Configuring the log handler comprises defining a Really Simple Syndication protocol feed channel for the log handler based on a loggable component of an application. Configuring the log handler comprises mapping a Really Simple Syndication protocol feed channel to a log of a component of an application. The mapping comprises registering a log handler to output a Really Simple Syndication protocol feed for a component of an application. The logging level is related to an importance and an urgency of a log message. Initiating a logging information feed from the log handler comprises automatically initiating the logging information feed from the log handler upon completion of configuring a log handler for a logger object and configuring a logging level for the logger object. Initiating a logging information feed from the log handler comprises configuring the logging information feed to initiate the logging information feed from the log handler. The logger object is a JAVA logger object.

### BRIEF DESCRIPTION OF THE DRAWINGS

Further features and advantages of the invention can be ascertained from the following detailed description that is provided in connection with the drawings described below:

FIG. 1 is an exemplary block diagram of a network system in which the present invention may be implemented.

FIG. 2a is an exemplary block diagram of a log framework, in which the present invention may be implemented.

FIG. 2b is an exemplary block diagram of a log framework, in which the present invention may be implemented.

FIG. 3 is an exemplary format of an RSS declaration document.

FIG. 4 is an exemplary flow diagram of a process for configuring and operating one or more RSS feeds according to the present invention.

FIG. 5 is an exemplary block diagram of a server, in which the present invention may be implemented.

### DETAILED DESCRIPTION OF THE PREFERRED EMBODIMENTS

In accordance with the present invention, a server provides access to its logging output by leveraging the Really Simple Syndication (RSS) protocol. This is a standard protocol for sharing content over the web. Multiple products exist in the market today for viewing RSS content and web browsers are lining up to support the protocol natively. This provides access to remote server logging information, which does not require specialized interfaces and which provides improved ease of use and improved comprehension of the logging information by the user.

RSS may be utilized in the present invention by defining a channel (or feed) per loggable component of the server. The available channels are defined in an RSS document made available by the server. The various logging channels can be mapped directly to component logs. For example, in Java, the java.util.logging package can be leveraged to define channels to which components log. By registering log handlers to output the RSS feeds for the components the java channels could be directly mapped to RSS channels.

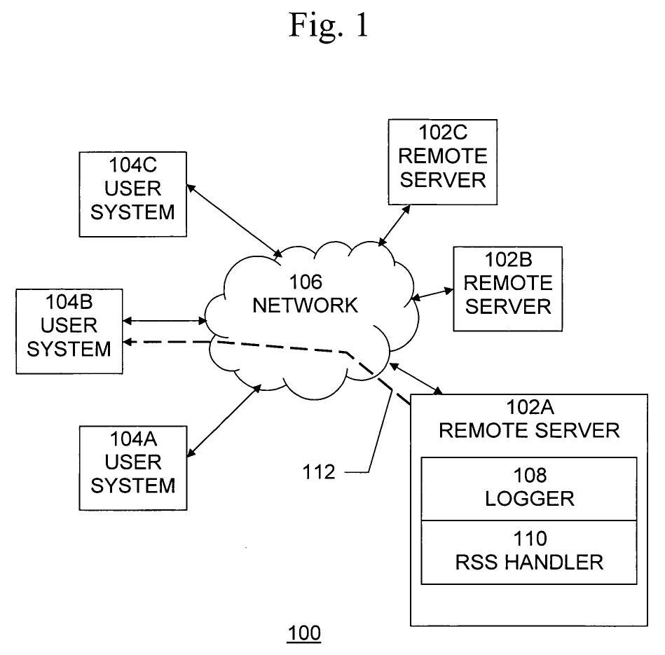

An exemplary network system 100, in which the present invention may be implemented, is shown in FIG. 1. System 100 includes one or more remote servers, such as remote servers 102A-C, one or more user systems, such as user systems 104A-C, and network 106. Remote servers 102A-C may be any type of server computer system running any type of server applications. For example, remote servers 102A-C may include application servers, which typically run complex transaction based applications, and backend servers running server applications such as web servers, mail servers, and data mining servers. User systems 104A-C include computer systems operated by users, including administrative users of network 106 and remote servers 102A-C. Network 106 may be any type of data communications network that provides communications among remote servers 102A-C and user systems 104A-C.

A remote server, such as remote server 102A, may include event logging software, such as logger 108. Such event logging software generates logging information based on events that occur in the operation of the computer system that the logging software is recording. In the example shown in FIG. 1, logger 108 records system events that occur in remote system 102A and generates logging information based on those events. Remote server 102A also includes RSS handler 110. RSS handler 110 receives at least a portion of the logging information generated by logger 108 and generates one or more RSS feeds 112 based on that logging information. The RSS feeds 112 are transmitted over network 106 to one or more user systems, such as user system 104B, where a user may examine the logging information as carried by the RSS feeds 112.

In a typical system, applications send information to be logged by making logging calls on Logger objects, such as logger 108. Logger 108 in turn passes this information, and other log related information, to Handler objects for publication. Both Loggers and Handlers may use logging levels and filters to decide if they are interested in particular logging information. Each log message has an associated log level. The level gives a rough guide to the importance and urgency of a log message. Applications send log requests to loggers. Each logger keeps track of a log level that it is interested in, and discards log requests that are below this level. In addition, loggers may use filters to determine which log requests they will handle based on criteria defined by the filters. When it is necessary to publish logging information externally, as is the case in the present invention, a Handler can use a Formatter to localize and format the message before publishing it to an I/O stream.

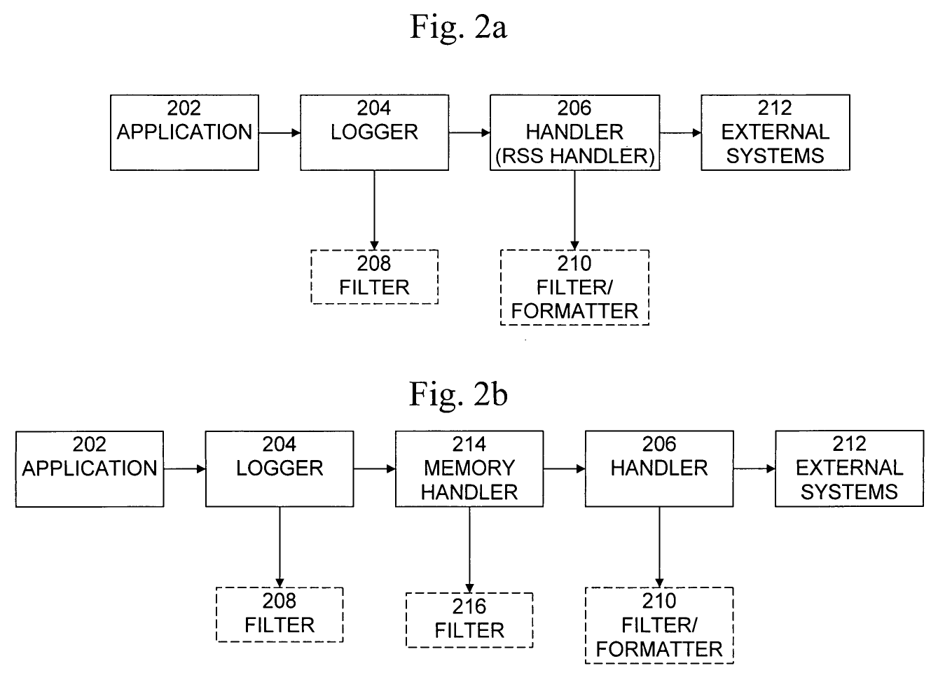

This log framework is shown in FIG. 2a. As shown in FIG. 2a, application 202 sends information to be logged by making logging calls on logger objects, such as logger 204. Logger 204 in turn passes this information, and other log related, information, to handler 206 for publication. In the present invention, handler 206 receives the logging information and processes so as to generate an RSS feed from the logging information. Such a handler may be termed an RSS handler. Both loggers and handlers may use logging levels and filters 208 or 210 to decide if they are interested in particular logging information. To publish logging information to external systems 212, a handler 206 can use a formatter 210 to localize and format the message before publishing it to an I/O stream.

An example of a log framework that may be used to implement the present invention is the JAVA UTILITY LOGGING FRAMEWORK.

Although the example shown in FIG. 2a only shows one handler 206, in fact, each logger may communicate with a set of output Handlers. For example, in FIG. 2b, a MemoryHandler 214 can maintain a circular buffer of log information without having to pay formatting costs.

Really Simple Syndication (RSS) is a lightweight XML format designed for sharing headlines and other Web content. RSS has evolved into a popular means of sharing content. RSS solves myriad problems webmasters commonly face, such as increasing traffic, and gathering and distributing news. RSS can also be the basis for additional content distribution services. RSS Syntax RSS defines an XML grammar (a set of HTML-like tags) for sharing news. Each RSS text file contains both static information about a site, plus dynamic information about new stories, all surrounded by matching start and end tags.

The Extensible Markup Language, commonly called XML, is a markup language for structured documents. A structured document is one that contains various elements, such as images and text, as well as an indication of what that element is. For example, a letter has elements such as address, body, and footer that all have different roles in the document. When there is some indicator on the letter as to what each part of each element does, then there is a structured document. Most documents do have structure, and XML can be used to define that structure in a usable, and standard, way. HTML documents are structured documents because they have elements and tags defining the role of that element. HTML and XML are not the same, however. HTML has a known set of tags. XML, on the other hand, does not. XML isn't just a way to mark up documents; it is really a meta-language giving developers a way to describe markups. The developers of the XML documents and applications that use them define the tags for the document as well as the relationship between those tags. XML was created to allow developers to use their tags to create structured documents for the Web.

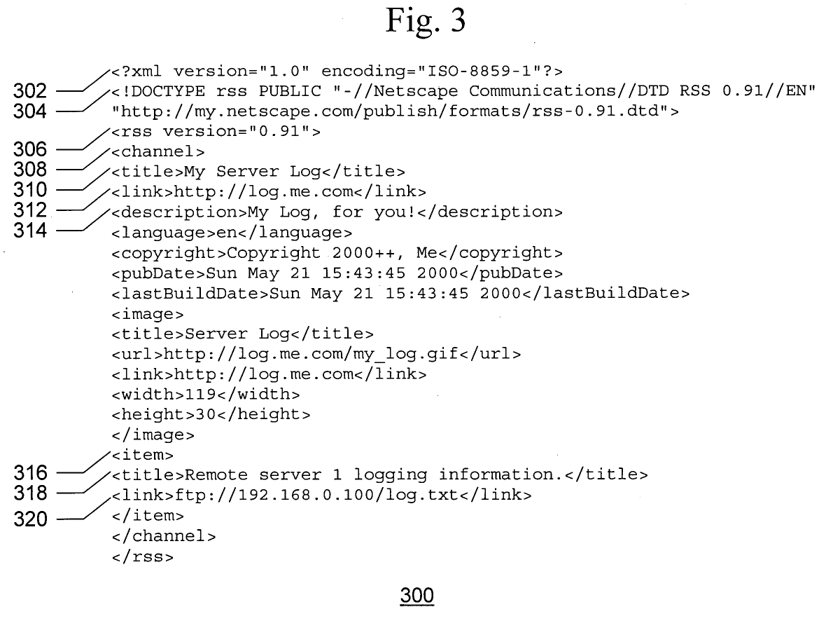

There is a finite set of tags to use with RSS. The main container for the document is the channel. Within this container there are a few elements that can be used to define the content. Three main elements are title, link, and description. The channel container can also contain image, textinput, and other containers. An example 300 of an RSS document is shown in FIG. 3. This document includes three declarations. Declaration 302 is declaring that this is an XML document. Declaration 304 is the DOCTYPE for the document. Declaration 306 is declaring that this is a RSS document, using version 0.91. It is to be noted that this version is merely an example; the present invention contemplates the use of any version of RSS, or of any similar or equivalent software functionality.

Once the type of document is defined, the document is created. Line 308 opens the channel container. Everything up until this containter is closed will be a part of this container. The main container in all RSS documents is channel. The document then includes a list of the elements being defined. The three main ones are title 310, which is the title of the channel; link 312, which is the location of the network element for this channel; and description 314, which is how to describe the channel.

The item container 316 is extremely important, since it defines the content of the channel. This container is required, and there can be multiple item containers per channel. For example, if there were five separate arrangements of logging information, there would be five item containers. There are two elements in an item container. These elements define the title of the item 318 as well as the link to the full body of logging information. The document ends by closing the channel container and closing the RSS document. This is equivalent to closing an HTML document with </HTML>.

Other elements of document 300 are optional, and may provide additional useful features relative to the logging information.

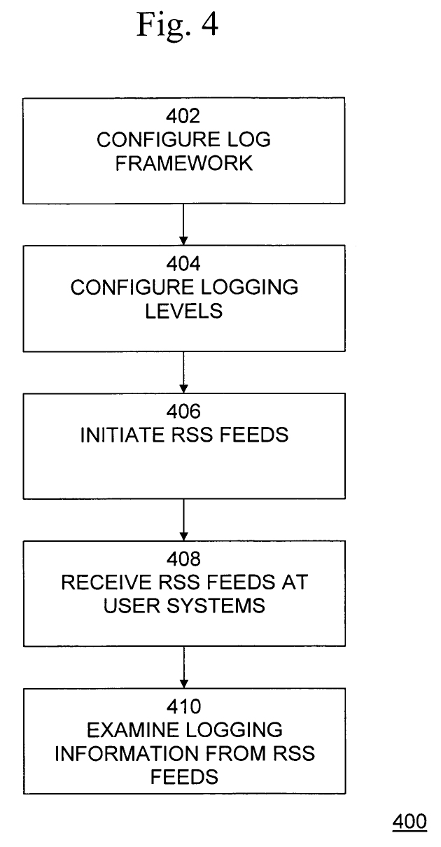

A process 400 for configuring and operating one or more RSS feeds for transmitting logging information is shown in FIG. 4. Process 400 begins with step 402, in which the log framework is configured to include RSS log handlers for loggers of interest. Each RSS log handler defines an available RSS feed channel based on each loggable component of the server applications. The available channels are defined in an RSS document made available by the server. The various logging channels can be mapped directly to component logs. For example, in Java the java.util.logging package can be leveraged to define channels to which components log. By registering log handlers to output the RSS feeds for the components the java channels could be directly mapped to RSS channels. In step 404, the logging levels of interest for each logger is configured. Each log message has an associated log level. The level gives a rough guide to the importance and urgency of a log message. Applications send log requests to loggers. Each logger keeps track of a log level that it is interested in, and discards log requests that are below this level. In step 406, the RSS feeds are initiated. In some implementations, RSS feed inititation may occur automatically upon completion of the log framework and log level configuration. In other implementations, there may be some sort of configuration required for initiating the RSS feeds from the web tier of the application server instances.

In step 408, one or more RSS feeds are received at one or more user systems. In step 410, at each user system, the logging information contained in each received RSS feed is examined by the user.

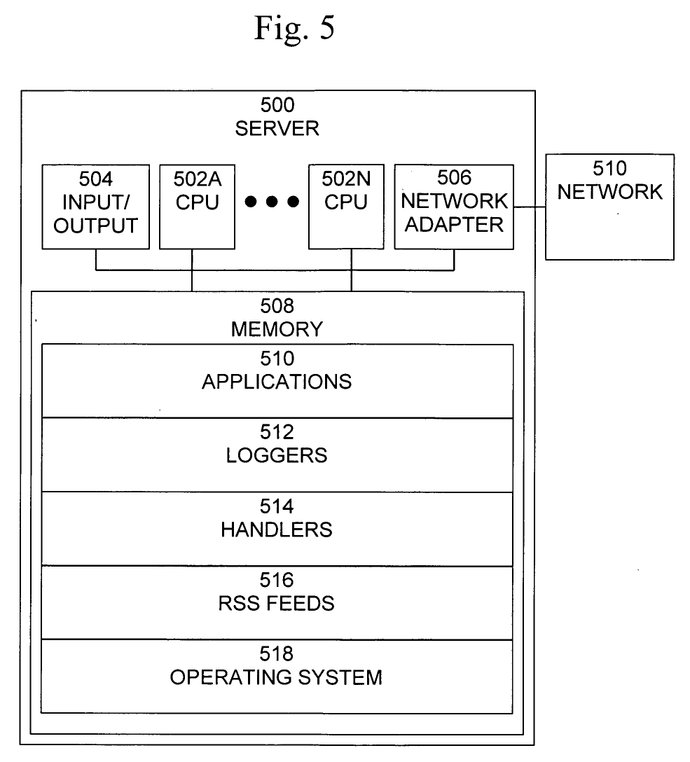

An exemplary block diagram of a server 500, in which the present invention may be implemented, is shown in FIG. 5. Server 500 is typically a programmed general-purpose computer system, such as a personal computer, workstation, server system, and minicomputer or mainframe computer. Server 500 includes one or more processors (CPUs) 502A-502N, input/output circuitry 504, network adapter 506, and memory 508. CPUs 502A-502N execute program instructions in order to carry out the functions of the present invention. Typically, CPUs 502A-502N are one or more microprocessors, such as an INTEL PENTIUM® processor. FIG. 5 illustrates an embodiment in which server 500 is implemented as a single multi-processor computer system, in which multiple processors 502A-502N share system resources, such as memory 508, input/output circuitry 504, and network adapter 506. However, the present invention also contemplates embodiments in which server 500 is implemented as a plurality of networked computer systems, which may be single-processor computer systems, multi-processor computer systems, or a mix thereof.

Input/output circuitry 504 provides the capability to input data to, or output data from, server 500. For example, input/output circuitry may include input devices, such as keyboards, mice, touchpads, trackballs, scanners, etc., output devices, such as video adapters, monitors, printers, etc., and input/output devices, such as, modems, etc. Network adapter 506 interfaces server 500 with network 510. Network 510 includes one or more data communication networks and may include one or more standard local area networks (LAN) or wide area networks (WAN), such as Ethernet, Token Ring, the Internet, or a private or proprietary LAN/WAN.

Memory 508 stores program instructions that are executed by, and data that are used and processed by, CPU 502 to perform the functions of server 500. Memory 508 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 508 vary depending upon the function that server 500 is programmed to perform. One of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 5, memory 508 includes applications 510, loggers 512, handlers 514, stuff 516, and operating system 518. Applications 510 include any type of server applications, such as application server applications, which are typically complex transaction based applications, and backend server applications, such as web server applications, mail server applications, and data mining server applications. Loggers 512 include event logging software that generates logging information based on events that occur in the operation of applications 510. Handlers 514 include software that receives the generated logging information from one or more loggers 512 and process the logging information in order to report the information or respond to the events. In particular, handlers 514 include one or more RSS handlers that receive at least a portion of the logging information generated by one or more logger 512 and generate one or more RSS feeds 516 based on that logging information. RSS feeds 516 include the logging information generated by one or more loggers 512 as processed by one or more handlers 514 into information feeds that are formatted in the RSS format. The RSS feeds 516 may be transmitted over network 510 to one or more user systems where a user may examine the logging information as carried by the RSS feeds. Operating system 518 provides overall system functionality.

As shown in FIG. 5, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of processing logging information comprising:
receiving logging information from an application, the logging information relating to an event of the application;
processing at least a portion of the received logging information to form an information feed; and
transmitting the formed information feed.

2. The method of claim 1, wherein the information feed is a Really Simple Syndication protocol feed.

3. The method of claim 2, wherein receiving logging information from an application comprises:
receiving logging information sent by a logging call made by the application at a logger object; and
passing the logging information to a handler.

4. The method of claim 3, wherein the processing comprises:
receiving the logging information at the handler; and
processing the received logging information at the handler to form the at least one Really Simple Syndication protocol feed.

5. The method of claim 4, wherein the logger object is a JAVA logger object.

6. A method of configuring a server to transmit logging information comprising:
configuring a log handler for a logger object;
configuring a logging level for the logger object; and
initiating a logging information feed from the log handler.

7. The method of claim 6, wherein the information feed is a Really Simple Syndication protocol feed.

8. The method of claim 7, wherein configuring the log handler comprises:
defining a Really Simple Syndication protocol feed channel for the log handler based on a loggable component of an application.

9. The method of claim 7, wherein configuring the log handler comprises:
mapping a Really Simple Syndication protocol feed channel to a log of a component of an application.

10. The method of claim 9, wherein the mapping comprises:
registering a log handlers to output a Really Simple Syndication protocol feed for a component of an application.

11. The method of claim 8, wherein the logging level is related to an importance and an urgency of a log message.

12. The method of claim 8, wherein initiating a logging information feed from the log handler comprises:
automatically initiating the logging information feed from the log handler upon completion of configuring a log handler for a logger object and configuring a logging level for the logger object.

13. The method of claim 8, wherein initiating a logging information feed from the log handler comprises:
configuring the logging information feed to initiate the logging information feed from the log handler.

14. The method of claim 8, wherein logger object is a JAVA logger object.

15. A system for processing logging information comprising:
a processor operable to execute computer program instructions;
a memory operable to store computer program instructions executable by the processor; and
computer program instructions stored in the memory and executable to perform:
receiving logging information from an application, the logging information relating to an event of the application;
processing at least a portion of the received logging information to form at least one information feed; and
transmitting at least one of the formed information feeds.

16. The system of claim 15, wherein the at least one information feed is a Really Simple Syndication protocol feed.

17. The system of claim 16, wherein receiving logging information from an application comprises:
receiving logging information sent by a logging call made by the application at a logger object; and
passing the logging information to a handler.

18. The system of claim 17, wherein the processing comprises:
receiving the logging information at the handler; and
processing the received logging information at the handler to form the at least one Really Simple Syndication protocol feed.

19. The system of claim 18, wherein the logger object is a JAVA logger object.

20. A system configurable to transmit logging information comprising:
a processor operable to execute computer program instructions;
a memory operable to store computer program instructions executable by the processor; and
computer program instructions stored in the memory and executable to perform:
configuring a log handler for a logger object;
configuring a logging level for the logger object; and
initiating a logging information feed from the log handler.

21. The system of claim 20, wherein the information feed is a Really Simple Syndication protocol feed.

22. The system of claim 21, wherein configuring the log handler comprises:
defining a Really Simple Syndication protocol feed channel for the log handler based on a loggable component of an application.

23. The system of claim 21, wherein configuring the log handler comprises:
mapping a Really Simple Syndication protocol feed channel to a log of a component of an application.

24. The system of claim 23, wherein the mapping comprises:
registering a log handlers to output a Really Simple Syndication protocol feed for a component of an application.

25. The system of claim 22, wherein the logging level is related to an importance and an urgency of a log message.

26. The system of claim 22, wherein initiating a logging information feed from the log handler comprises:
automatically initiating the logging information feed from the log handler upon completion of configuring a log handler for a logger object and configuring a logging level for the logger object.

27. The system of claim 22, wherein initiating a logging information feed from the log handler comprises:
configuring the logging information feed to initiate the logging information feed from the log handler.

28. The system of claim 22, wherein logger object is a JAVA logger object.

29. A computer program product for processing logging information comprising:
a computer readable medium;
computer program instructions, recorded on the computer readable medium, executable by a processor, for performing:
receiving logging information from an application, the logging information relating to an event of the application;
processing at least a portion of the received logging information to form at least one information feed; and
transmitting at least one of the formed information feeds.

30. The computer program product of claim 29, wherein the at least one information feed is a Really Simple Syndication protocol feed.

31. The computer program product of claim 30, wherein receiving logging information from an application comprises:
receiving logging information sent by a logging call made by the application at a logger object; and
passing the logging information to a handler.

32. The computer program product of claim 31, wherein the processing comprises:
receiving the logging information at the handler; and
processing the received logging information at the handler to form the at least one Really Simple Syndication protocol feed.

33. The computer program product of claim 32, wherein the logger object is a JAVA logger object.

34. A computer program product for configuring a server to transmit logging information comprising:
a computer readable medium;
computer program instructions, recorded on the computer readable medium, executable by a processor, for performing:
configuring a log handler for a logger object;
configuring a logging level for the logger object; and
initiating a logging information feed from the log handler.

35. The computer program product of claim 34, wherein the information feed is a Really Simple Syndication protocol feed.

36. The computer program product of claim 35, wherein configuring the log handler comprises:
defining a Really Simple Syndication protocol feed channel for the log handler based on a loggable component of an application.

37. The computer program product of claim 35, wherein configuring the log handler comprises:
mapping a Really Simple Syndication protocol feed channel to a log of a component of an application.

38. The computer program product of claim 37, wherein the mapping comprises:
registering a log handlers to output a Really Simple Syndication protocol feed for a component of an application.

39. The computer program product of claim 36, wherein the logging level is related to an importance and an urgency of a log message.

40. The computer program product of claim 36, wherein initiating a logging information feed from the log handler comprises:
automatically initiating the logging information feed from the log handler upon completion of configuring a log handler for a logger object and configuring a logging level for the logger object.

41. The computer program product of claim 36, wherein initiating a logging information feed from the log handler comprises:
configuring the logging information feed to initiate the logging information feed from the log handler.

42. The computer program product of claim 36, wherein logger object is a JAVA logger object.
